(19) United States
(12) Patent Application Publication
(10) Pub. No.: US 2026/0365463 A1
(43) Pub. Date: Nov. 19, 2026

(54) AUTOMATED SYSTEM FOR UNLOADING INTERLACED TIRES FROM TRUCK TRAILERS

(71) Applicant: FANUC AMERICA CORPORATION, Rochester Hills, MI (US)

(72) Inventors: Amardeep Dhaliwal, Windsor (CA); Nandeep Shah, Royal Oak, MI (US); Christopher Stolp, Waterford, MI (US); Maulesh Trivedi, Rochester Hills, MI (US)

(21) Appl. No.: 19/670,589

(22) Filed: May 7, 2026

Related U.S. Application Data
(60) Provisional application No. 63/806,381, filed on May 15, 2025.

(51) Int. Cl. B65G 67/24; B25J 5/00; B25J 9/00; B25J 9/16; G05D 1/648

(52) U.S. Cl. CPC B65G 67/24; B25J 5/00; B25J 9/0093; B25J 9/163; G05D 1/648; B65G 2201/0273; B65G 2814/031

(57) ABSTRACT

A system for unloading interlaced tires. The system includes a transfer unit being movable on tracks or wheels; a robot mounted to the transfer unit, where the robot includes a robot arm and an end-of-arm tool coupled to the arm, and where the end-of-arm tool is configured to grasp tires; and a conveyor attached to the transfer unit and being movable therewith. The transfer unit moves the robot to a position to allow the end-of-arm tool to grasp a tire and the robot places the grasped tire on the conveyor.

### CROSS-REFERENCE TO RELATED APPLICATIONS

This application claims the benefit of the filing date of US Provisional Application No. 63/806,381, filed May 15, 2025, titled Automated System for Unloading Interlaced Tires From Truck Trailers.

### BACKGROUND

### Field

This disclosure relates generally to an automated system for unloading tires and, more particularly, to an automated robotic system for unloading tires from a truck trailer and placing them on a conveyor.

### DISCUSSION OF THE RELATED ART

Vehicle manufacturers require a lot of tires. Those tires are typically delivered in truck trailers or sea containers. Typically, the tires are delivered to a third-party repacking facility where they are manually unloaded and placed on pallets. The pallets of tires are then reloaded onto trailers or sea containers and sent to automotive manufacturing plants for unloading by forklift drivers. Requiring the third-party repacking facility significantly adds to the cost. Currently there is no existing automated solution for unloading loose tires from trailers or sea containers.

### SUMMARY

The following discussion discloses and describes an automated system for unloading interlaced tires. The system includes a transfer unit being movable on tracks or wheels; a robot mounted to the transfer unit, where the robot includes a robot arm and an end-of-arm tool coupled to the arm, and where the end-of-arm tool is configured to grasp tires; and a conveyor attached to the transfer unit and being movable therewith. The transfer unit moves the robot to a position to allow the end-of-arm tool to grasp a tire and the robot places the grasped tire on the conveyor.

Additional features of the disclosure will become apparent from the following description and appended claims, taken in conjunction with the accompanying drawings.

### BRIEF DESCRIPTION OF THE DRAWING

FIG. 1 is an illustration of an automated tire unloading system that is unloading tires from a trailer.

### DETAILED DESCRIPTION OF THE EMBODIMENTS

The following discussion of the embodiments of the disclosure directed to an automated system for unloading tires is merely exemplary in nature, and is in no way intended to limit the disclosure or its applications or uses.

This disclosure describes an automated tire unloading system designed for unloading tires from truck trailers or sea containers. The system includes a robot mounted on an automated guided vehicle (AGV) or automatically guided transfer unit that operates on tracks or wheels. The transfer unit employs machine vision and artificial intelligence to learn and identify the orientation and position of the tires to optimize the tire unloading process. The transfer unit includes sensors to keep it centered within the trailer by monitoring the location of the transfer unit with respect to the trailer sides. The robot includes a specially designed end-of-arm tool that is configured to effectively grasp the tires. The tires are placed on a conveyor that is pulled along with the robot as the transfer unit moves into the trailer or sea container as the tires are being unloaded.

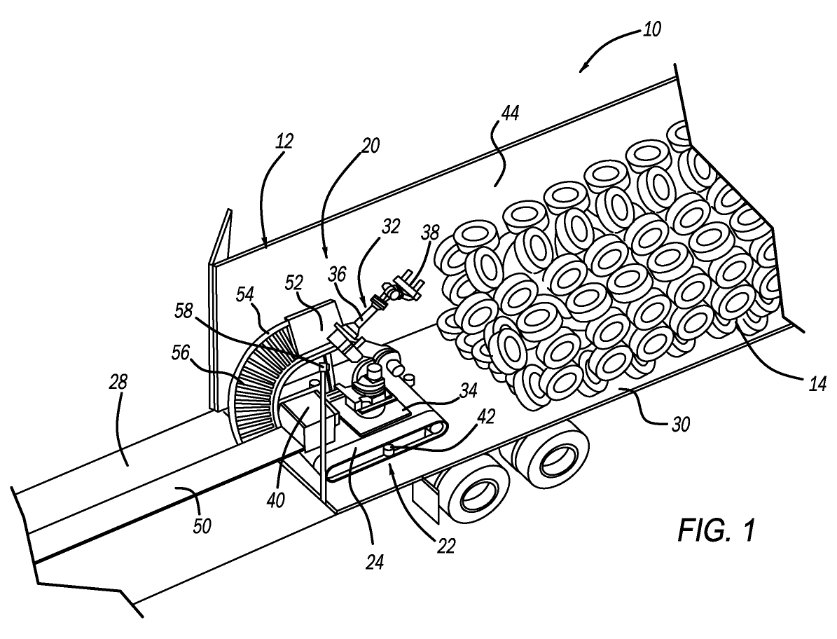

FIG. 1 is an illustration 10 showing a broken-away view of a truck trailer 12 containing many stacked and interlaced tires 14 within the trailer 12. The illustration 10 also shows an automated tire unloading system 20 as one exemplary embodiment of the tire unloading system described above. The system 20 includes an automatically guided robot transfer unit 22 having tracks 24 that allow the unit 22 to navigate up a ramp 28 and onto the bed 30 of the trailer 12 towards the stack of the tires 14. In an alternate embodiment, the tracks 24 can be replaced with wheels. A robot 32, such as an 8-axis robot, is mounted to a top plate 34 of the transfer unit 22 and includes a robot arm 36 and an end-of-arm tool 38 attached thereto that is effective for grasping the tires 14. The system 20 includes an AI-powered control unit 40 mounted to the unit 22 that receives various sensor signals and controls the movement of the robot 32 and the position of the transfer unit 22. The end-of-arm tool 38 grasps the tire 14 by the inner wheel. The tire grasp force is monitored by the control unit 40 to stop the grasp pressure of the end-of-arm tool 38 before damage can occur to the tire 14. The amount of force induced by grasping the tire 14 allows the system 20 to unload a wide range of the tires 14 without making mechanical changes to the end-of-arm tool 38 for different types of tires. A tire detection algorithm operating in the control unit 40 returns the optimal pick-point of the tire 14 while incorporating the end-of-arm tool 38 in its heuristics. This AI and computer vision guided tooling solution ensures collision avoidance as well as dynamic and robust motion planning that maximizes the overall throughput of the system 20.

The transfer unit 22 includes sensors 42 placed at various and suitable locations on the unit 22 that monitor the location of the unit 22 relative to the sides 44 of the trailer 12 to allow the control unit 40 to maintain the unit 22 centered within the trailer 12. A conveyor 50 is secured to the back of the transfer unit 22 and is pulled along as the transfer unit 22 moves into the trailer 12 towards the stack of the tires 14 as the tires 14 are being removed. A tire catch 52 is mounted to the transfer unit 22 adjacent to the robot 32 and a slide 54 with rollers 56 is secured to the catch 52 and the conveyor 50. The tool 38 will grasp a tire 14 and the robot 32 will rotate to allow the tool 38 to place the tire 14 on the catch 52 in a manner that causes the tire 14 to slide down the slide 54 and onto the conveyor 50 to be transferred to a receiving location (not shown). The system 20 employs a number of cameras 58, such as RGB sensors, depth sensors, inclinometers, safety sensors, LiDARs, etc., to identify the orientation and position of the interlaced tires 14 to optimize the tire unloading process.

The system 20 employs AGV technologies that handle the tight tolerances and variability of a dock environment, including, for example, different dock heights, different truck bed heights, etc. The autonomous end-to-end tire unloading integrates AI-driven navigation, manipulation, and perception technologies in the control unit 40 to provide a system that has the potential to be adapted across manufacturing and warehouse industries. The compact mechanical design of the system 20 offers maneuverability in tight spaces and the advanced control unit 40 incorporates algorithms that optimize coordination between the robot 32 and the transfer unit 22.

An AI-driven decision making and control architecture resides at the core of the system 20. Advanced probabilistic robotics are employed using techniques such as Markov decision processes and reinforcement learning for optimizing unloading strategies in dynamic environments, such as variable trailer loading patterns, variable tire patterns, etc. Deep learning AI models in the control unit 40 are employed for precise detection and classification of diverse interlaced tire load types. 3D cameras are leveraged for point cloud analysis enabling accurate path planning and arm movement. Advanced semantic segmentation algorithms can be used to identify critical features such as tire boundaries, obstacles, and safety zones. Simultaneous localization and mapping (SLAM) algorithms can be employed in the control unit 40 for dynamic scene understanding within confined and variable spaces inside trailers.

The system 20 incorporates AI driven computer vision for enhanced perception and real-time object detection for navigation and unloading. The AI models are paired with advanced 3D point-cloud analysis and semantic segmentation for identifying unique features on the tires 14 and locate object boundaries with high precision. Multi-Modal sensor fusion integrates data from RGB sensors, depth sensors, inclinometers, safety sensors, and LiDARs for a robust environmental perception.

Because the interlaced tires 14 are in a random pattern, assumptions of the tire locations will be interpreted based on the position of other tires and these patterns will lead to a model. Dedicated AI models can be employed for diverse tire patterns (interlaced as well as stacked). The system 20 will also have active learning pipelines so that the system 20 can continually be improved by re-training models on new tire patterns and edge cases encountered during operation. The AI models can be paired with advanced point cloud analysis and semantic segmentation algorithms for precise boundary detection and pick-point generation. Cloud Integration can be employed for collaborative AI model training across multiple AGVs spread across facilities ensuring robustness and scalability. The AI model can also incorporate data augmentation techniques that allow AI model training even with a relatively small data set. This plug-and-play architecture means AI-optimized modular components for easy upgrades and reconfiguration across different environments and industries.

The machine vision and artificial intelligence continually optimizes the unloading of the interlaced tires 14. The AI model will over time make decisions on which tire 14 to approach for unload based on past success and failure and other model characteristics. Dynamic scene understanding can be incorporated in the control unit 40 for precise navigation within the trailer 12. The AI-Vision system returns an optimal best-pick from an interlaced pattern of the tires 14 that is then sent to the robot 32. Advanced path planning is employed in the control unit 40 with optimized inverse kinematics as well as trajectory prediction models to ensure a smooth and collision free motion.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A system for unloading tires from a stack of the tires, said system comprising:
a movable transfer unit;
a robot mounted to the transfer unit, said robot including a robot arm and an end-of-arm tool coupled to the arm, said end-of-arm tool being configured to grasp the tires; and
a conveyor attached to the transfer unit and being movable therewith, said transfer unit moving the robot to a position that allows the end-of-arm tool to grasp a tire, said robot placing the grasped tire on the conveyor.

2. The system according to claim 1 further comprising an AI-powered control unit mounted to the transfer unit that controls the robot and the position of the transfer unit.

3. The system according to claim 2 wherein the AI-power control unit employs one or more of Markov decision processes and reinforcement learning for optimizing unloading strategies, deep learning AI models for precise detection and classification of diverse interlaced tire load types, advanced semantic segmentation algorithms for identifying critical features such as tire boundaries, obstacles and safety zones, and simultaneous localization and mapping (SLAM) algorithms for dynamic scene understanding within confined and variable spaces inside trailers.

4. The system according to claim 1 wherein the transfer unit includes tracks or wheels that move the transfer unit.

5. The system according to claim 1 wherein the tires are stacked in a truck trailer and the transfer unit is movable within the trailer.

6. The system according to claim 5 wherein the transfer unit includes one or more sensors that monitor the location of the transfer unit relative to sides of the trailer to maintain the transfer unit centered within the trailer.

7. The system according to claim 1 further comprising a plurality of cameras that identify the orientation and position of the tires.

8. The system according to claim 7 wherein the cameras include RGB sensors, depth sensors, inclinometers, safety sensors or LiDARs.

9. The system according to claim 1 further comprising a tire catch secured to the transfer unit adjacent to the robot and a slide coupled to the catch and the conveyor, wherein the robot places the grasped tire on the catch which causes the tire to slide down the slide and land on the conveyor.

10. A system for unloading tires from a stack of the tires stacked in a container, said system comprising:
an automated transfer unit;
a robot mounted to the transfer unit, said robot including a robot arm extending towards a front of the transfer unit and an end-of-arm tool coupled to the arm, said end-of-arm tool being configured to grasp the tires, wherein the transfer unit includes one or more sensors that monitor the location of the transfer unit relative to sides of the container to maintain the transfer unit centered within the container;
a conveyor attached to a rear of the transfer unit and being movable therewith, said transfer unit moving the robot to a position that allows the end-of-arm tool to grasp a tire, said robot placing the grasped tire on the conveyor;
a plurality of cameras that identify the orientation and position of the tires; and
a control unit that controls the robot and the position of the transfer unit.

11. The system according to claim 10 wherein the control unit is an AI-powered control unit.

12. The system according to claim 11 wherein the AI-power control unit employs one or more of Markov decision processes and reinforcement learning for optimizing unloading strategies, deep learning AI models for precise detection and classification of diverse interlaced tire load types, advanced semantic segmentation algorithms for identifying critical features such as tire boundaries, obstacles and safety zones, and simultaneous localization and mapping (SLAM) algorithms for dynamic scene understanding within confined and variable spaces inside trailers.

13. The system according to claim 10 further comprising a tire catch secured to the transfer unit adjacent to the robot and a slide coupled to the catch and the conveyor, wherein the robot places the grasped tire on the catch which causes the tire to slide down the slide and land on the conveyor.

14. The system according to claim 10 wherein the cameras include RGB sensors, depth sensors, inclinometers, safety sensors or LiDARs.

15. The system according to claim 10 wherein the container is a truck trailer or a sea container.

16. The system according to claim 10 wherein the transfer unit includes tracks or wheels that move the transfer unit.

17. A system for unloading tires from a stack of the tires stacked in a container, said system comprising:
an automated transfer unit movable on tracks or wheels;
a robot mounted to the transfer unit, said robot including a robot arm extending towards a front of the transfer unit and an end-of-arm tool coupled to the arm, said end-of-arm tool being configured to grasp the tires, wherein the transfer unit includes one or more sensors that monitor the location of the transfer unit relative to sides of the container to maintain the transfer unit centered within the container;
a conveyor attached to a rear of the transfer unit and being movable therewith;
a tire catch secured to the transfer unit adjacent to the robot and a slide coupled to the catch and the conveyor, said transfer unit moving the robot to a position that allows the end-of-arm tool to grasp a tire, said robot placing the grasped tire on the catch which causes the tire to slide down the slide and land on the conveyor; and
an AI controlled control unit that controls the robot and the position of the transfer unit.

18. The system according to claim 17 further comprising a plurality of cameras that identify the orientation and position of the tires.

19. The system according to claim 17 wherein the transfer unit includes one or more sensors that monitor the location of the transfer unit relative to sides of the trailer to maintain the transfer unit centered within the trailer.

20. The system according to claim 17 wherein the container is a truck trailer or a sea container.
